(19) United States
(12) Patent Application Publication
(10) Pub. No.: US 2025/0305551 A1
(43) Pub. Date: Oct. 2, 2025

(54) TUBULAR VIBRATION-DAMPING DEVICE

(71) Applicant: SUMITOMO RIKO COMPANY LIMITED, Komaki-shi (JP)

(72) Inventors: Mitsuru SASAKI, Komaki-shi (JP); Hiroto Shinno, Atsugi-shi (JP); Masao Hayashi, Atsugi-shi (JP); Atsushi Suzuki, Atsugi-shi (JP)

(73) Assignee: SUMITOMO RIKO COMPANY LIMITED, Komaki-shi (JP)

(21) Appl. No.: 19/036,228

(22) Filed: Jan. 24, 2025

(30) Foreign Application Priority Data
Mar. 26, 2024 (JP) 2024-049085

(51) Int. Cl. F16F 1/38

(52) U.S. Cl. CPC F16F 1/38; F16F 2224/02; F16F 2230/02; F16F 2230/36; F16F 2234/02

(57) ABSTRACT

A tubular vibration-damping device including a tubular resin outer member including a detent protrusion protruding from its outer circumferential surface, an inner shaft member inserted through the resin outer member, and a main rubber elastic body interconnecting the two members. A tubular collar member into which the resin outer member is fitted includes a window into which the detent protrusion is inserted. A gap is provided between the window and the detent protrusion on a distal end side in a direction of fit of the resin outer member and on both sides in a circumferential direction. An end surface of the detent protrusion on a proximal end side in the direction of fit is a locking surface inclining radially outward toward the distal end side in the direction of fit, and the collar member is axially locked to the locking surface.

### INCORPORATED BY REFERENCE

The disclosure of Japanese Patent Application No. 2024-049085 filed on Mar. 26, 2024 including the specification, drawings and abstract is incorporated herein by reference in its entirety.

### BACKGROUND ART

### 1. Technical Field

The present disclosure relates to a tubular vibration-damping device used as an automotive sub-frame mount or the like, for example.

### 2. Description of the Related Art

Conventionally, tubular vibration-damping devices used as automotive sub-frame mounts or the like have been known. As disclosed in Japanese Unexamined Patent Publication No. JP-A-2010-078101, for example, a tubular vibration-damping device has a structure in which an inner shaft member and an outer tube member are connected by a main rubber elastic body.

### SUMMARY

Meanwhile, conventionally, the outer tube member was made of metal, such as iron and aluminum alloy, but in JP-A-2010-078101, it is proposed that the outer tube member be made of synthetic resin in order to reduce the weight of the tubular vibration-damping device.

However, when an outer tube member made of synthetic resin (a resin outer member) is used by being fitted into a collar member such as a sub frame, for example, the resin outer member is likely to experience time-dependent changes in shape and dimensions (permanent deformation) due to the continuous action of the fitting force acting radially inward. The permanent deformation may deteriorate the resistance force to dislodgment, posing a risk of dislodgment of the resin outer member from the collar member.

JP-A-2010-078101 also proposes forming a circular detent protrusion protruding from the outer circumferential surface of the resin outer member and locking the detent protrusion to a corresponding circular window of the collar member so as to ensure resistance to dislodgement. In JP-A-2010-078101, the detent protrusion is locked to the opening peripheral rim of the window with the edge of the opening peripheral rim of the circular window wedged into the peripheral wall face of the tapered circular detent protrusion.

However, in the structure of JP-A-2010-078101, it is necessary to position the center points of the detent protrusion and the window relative to each other with sufficient accuracy. If the relative positions of the detent protrusion and the window are misaligned due to dimensional errors or the like, the window overrides the detent protrusion in a point contact state in the circumferential direction of the circle, and gaps will occur in other areas. This may pose a risk that the desired detent action will not be effectively exhibited.

In particular, because the detent protrusion is provided at the outer peripheral end of the tubular vibration-damping device, even a slight misalignment of the central angles between the tubular vibration-damping device and the collar member is likely to cause a large misalignment in the circumferential direction between the detent protrusion and the window, and a problem of misalignment in the circumferential direction between detent protrusion and the window tends to arise. In addition, the detent protrusions and the windows that are locked to each other are provided in pairs, with each pair spaced away in the circumferential direction. Thus, any dimensional error in either of the pairs of detent protrusion and window affects both, making it even more difficult to accurately align the center points of each pair of detent protrusion and window and lock them.

It is therefore one object of the present disclosure to provide tubular vibration-damping device of novel structure which is able to stably obtain the resistance to dislodgement of the resin outer member from the collar member.

Hereinafter, preferred embodiments for grasping the present disclosure will be described. However, each preferred embodiment described below is exemplary and can be appropriately combined with each other. Besides, a plurality of elements described in each preferred embodiment can be recognized and adopted as independently as possible, or can also be appropriately combined with any element described in other preferred embodiments. By so doing, in the present disclosure, various other preferred embodiments can be realized without being limited to those described below.

A first preferred embodiment provides a tubular vibration-damping device comprising: a resin outer member having a tubular shape and including a detent protrusion that protrudes from an outer circumferential surface of the resin outer member; an inner shaft member inserted through the resin outer member; and a main rubber elastic body connecting the inner shaft member and the resin outer member to each other, wherein a collar member having a tubular shape into which the resin outer member is fitted includes a window into which the detent protrusion is inserted, around the detent protrusion, a gap is provided between the window and the detent protrusion on a distal end side in a direction of fit of the resin outer member into the collar member and between the window and the detent protrusion on both sides in a circumferential direction, and an end surface of the detent protrusion on a proximal end side in the direction of fit of the resin outer member into the collar member comprises a locking surface that inclines radially outward toward the distal end side in the direction of fit, and the collar member is locked to the locking surface in an axial direction.

According to the tubular vibration-damping device structured following the present preferred embodiment, around the detent protrusion, the gap is formed between the window and the detent protrusion on the distal end side in the direction of fit of the resin outer member into the collar member and between the window and the detent protrusion on both sides in the circumferential direction. With this configuration, relative positional misalignment between the detent protrusion and the window is allowed by the gap.

Besides, the end surface of the detent protrusion on the proximal end side in the direction of fit of the resin outer member into the collar member comprises the locking surface that inclines radially outward toward the distal end side in the direction of fit, and the collar member is locked to the locking surface in the axial direction. In this way, the portion of the circumferential wall face of the detent protrusion that is locked with the opening peripheral rim of the window comprises the locking surface that has a certain width in the axial direction. Thus, even if relative positional misalignment in the axial direction occurs between the detent protrusion and the window, the detent protrusion and the opening peripheral rim of the window are stably locked. Accordingly, the desired resistance to dislodgement is effectively exerted, while preventing the resin outer member and the collar member from rattling or the like.

A second preferred embodiment provides the tubular vibration-damping device according to the first preferred embodiment, wherein an end surface of the detent protrusion on the distal end side in the direction of fit of the resin outer member into the collar member comprises a guiding surface that inclines radially outward toward the proximal end side in the direction of fit, and an inclination angle of the guiding surface with respect to the direction of fit is smaller than that of the locking surface.

According to the tubular vibration-damping device structured following the present preferred embodiment, when the collar member climbs over the detent protrusion, the collar member is guided by the guiding surface, thereby reducing the force required to fit the resin outer member into the collar member. Moreover, the inclination angle of the guiding surface with respect to the direction of fit is smaller than that of the locking surface. This makes it easier to prevent the collar member from getting caught on the guiding surface or the like, thereby further reducing the force required when the collar member climbs over the detent protrusion.

A third preferred embodiment provides the tubular vibration-damping device according to the first or second preferred embodiment, wherein the detent protrusion is provided on each side in a diametrical direction.

According to the tubular vibration-damping device structured following the present preferred embodiment, the resistance to dislodgement exerted by the detent protrusion and the window of the collar member being locked to each other on each side in the diametrical direction acts in a balanced manner in the circumferential direction, thereby preventing the resin outer member from tilting with respect to the collar member, or the like, for example. In the present preferred embodiment, as long as the detent protrusion is provided on each side in the diametrical direction, the detent protrusion may be provided in plurality on each side. However, for example, if one detent protrusion is provided on each side in the diametrical direction, the force required for fitting can be minimized while obtaining the resistance to dislodgement in a balanced manner in the circumferential direction. Meanwhile, the collar member includes the window formed in the portion corresponding to the detent protrusion on each side in the diametrical direction.

A fourth preferred embodiment provides the tubular vibration-damping device according to any one of the first through third preferred embodiments, wherein the gap between the window and the detent protrusion is made larger in the circumferential direction than in the axial direction.

According to the tubular vibration-damping device structured following the present preferred embodiment, the detent protrusion that protrudes from the outer circumferential surface of the resin outer member is remote from the center axis of the resin outer member, so that even if the resin outer member and the collar member are misaligned in the circumferential direction by a slight angle, there is a risk that the detent protrusion may be misaligned significantly in the circumferential direction with respect to the window. On the other hand, the relative positions of the detent protrusion and the window in the axial direction can be set with comparatively high precision, and the misalignment can be made smaller than that of the relative positions in the circumferential direction. Therefore, by making the circumferential gap between the detent protrusion and the window larger than the axial gap therebetween, it is possible to sufficiently allow the relative misalignment in orientation in the circumferential direction between the resin outer member and the collar member, which is likely to be comparatively large, while reducing the size of the window.

A fifth preferred embodiment provides the tubular vibration-damping device according to any one of the first through fourth preferred embodiments, wherein the locking surface of the detent protrusion and an opening peripheral rim of the window of the collar member locked to the locking surface both extend in a direction perpendicular to the axial direction.

According to the tubular vibration-damping device structured following the present preferred embodiment, the locking surface of the detent protrusion and the opening peripheral rim of the window of the collar member, which are locked to each other, are perpendicular to the axial direction, which is the direction of dislodgment of the resin outer member from the collar member. This makes it possible to efficiently obtain the resistance to dislodgement due to the detent protrusion and the opening peripheral rim of the window being locked to each other.

A sixth preferred embodiment provides the tubular vibration-damping device according to the fifth preferred embodiment, wherein when viewed in a direction of protrusion of the detent protrusion, the detent protrusion and the window include respective pairs of first opposite sides extending in the direction perpendicular to the axial direction and respective pairs of second opposite sides extending in the axial direction.

According to the tubular vibration-damping device structured following the present preferred embodiment, the circumferential gap is approximately constant in size entirely in the axial direction, thereby allowing positional misalignment in the circumferential direction between the detent protrusion and the window with good space efficiency. Similarly, the axial gap is approximately constant in size entirely in the circumferential direction, thereby allowing positional misalignment in the axial direction between the detent protrusion and the window with good space efficiency.

Besides, the distal side end of the detent protrusion in the direction of fit comprises the first opposite side that is perpendicular to the axial direction. Thus, when the collar member climbs over the detent protrusion, the resin outer member and the collar member are less prone to incline relative to each other, so that stable fit is possible.

According to the present disclosure, the tubular vibration-damping device is able to stably obtain the resistance to dislodgement of the resin outer member from the collar member.

### BRIEF DESCRIPTION OF THE DRAWINGS

The foregoing and/or other objects, features and advantages of the disclosure will become more apparent from the following description of a practical embodiment with reference to the accompanying drawings in which like reference numerals designate like elements and wherein:

FIG. 1 is a front view of a tubular vibration-damping device in the form of a sub-frame mount as a first practical embodiment of the present disclosure, which is shown in a mounted state to a collar member;

FIG. 2 is a cross sectional view taken along line 2-2 of FIG. 1; and

FIG. 3 is a cross sectional view taken along line 3-3 of FIG. 1.

### DETAILED DESCRIPTION

Hereinafter, a practical embodiment of the present disclosure will be described with reference to the drawings.

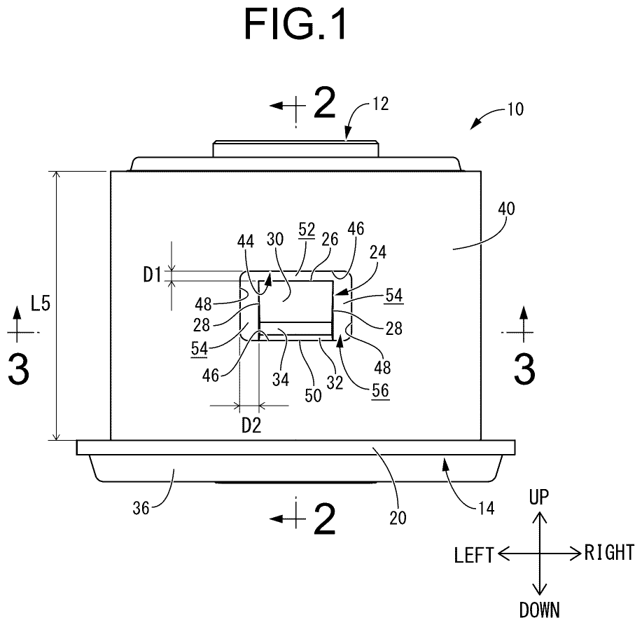

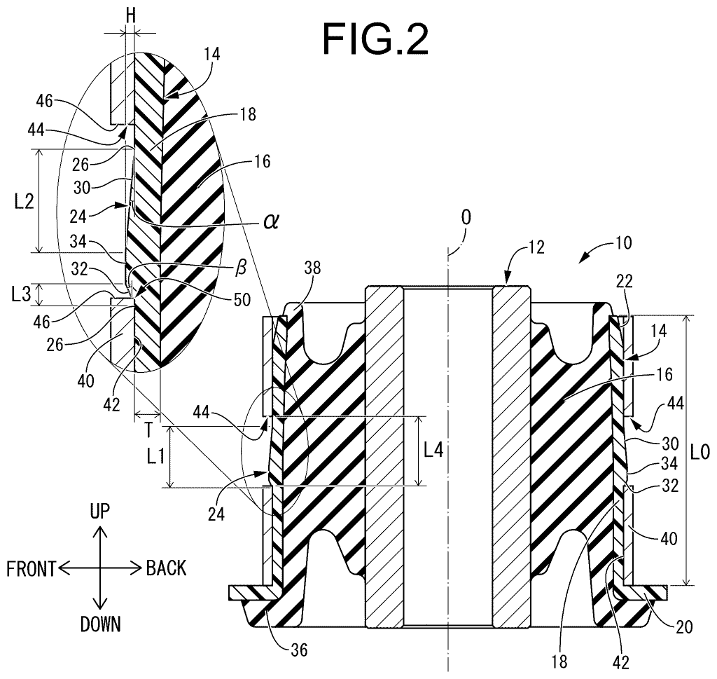

FIGS. 1 to 3 show an automotive sub-frame mount 10 in a mounted state to a collar member 40, which will be described later, as a first practical embodiment of a tubular vibration-damping device constructed according to the present disclosure. The sub-frame mount 10 has a structure in which an inner shaft member 12 is inserted through a tubular resin outer member 14, and the inner shaft member 12 and the resin outer member 14 are connected by a main rubber elastic body 16. In the following description, as a general rule, the vertical direction refers to the vertical direction in FIG. 1, which is the axial direction, the front-back direction refers to the left-right direction in FIG. 2, and the left-right direction refers to the left-right direction in FIG. 1.

The inner shaft member 12 has a thick-walled, small-diameter, approximately round tubular shape, and extends straight with an approximately constant cross-sectional shape. The inner shaft member 12 is made of metal such as iron and aluminum alloy, fiber-reinforced synthetic resin, or the like, for example, and is a rigid member.

The resin outer member 14 includes a tubular part 18 having an approximately round tubular shape. The tubular part 18 is thinner and larger in diameter than the inner shaft member 12. The resin outer member 14 is made of synthetic resin, and is made of, for example, polyamide, polyacetal, polybutylene terephthalate, polyethylene, polytetrafluoroethylene, or the like. The resin outer member 14 may be made of the above-mentioned synthetic resin material alone, but it may also be made of fiber-reinforced synthetic resin that is reinforced with glass fiber, carbon fiber, aramid fiber, or the like.

A flanged part 20 having an annular disk shape that protrudes radially outward is integrally formed with the lower end of the resin outer member 14. The outer circumferential surface of the upper end of the resin outer member 14 comprises a tapered surface 22 that upwardly decreases in diameter. The inner circumferential surface of the upper end of the resin outer member 14 protrudes radially inward compared to the inner circumferential surface of other portions, but is made thinner upward by the formation of the tapered surface 22.

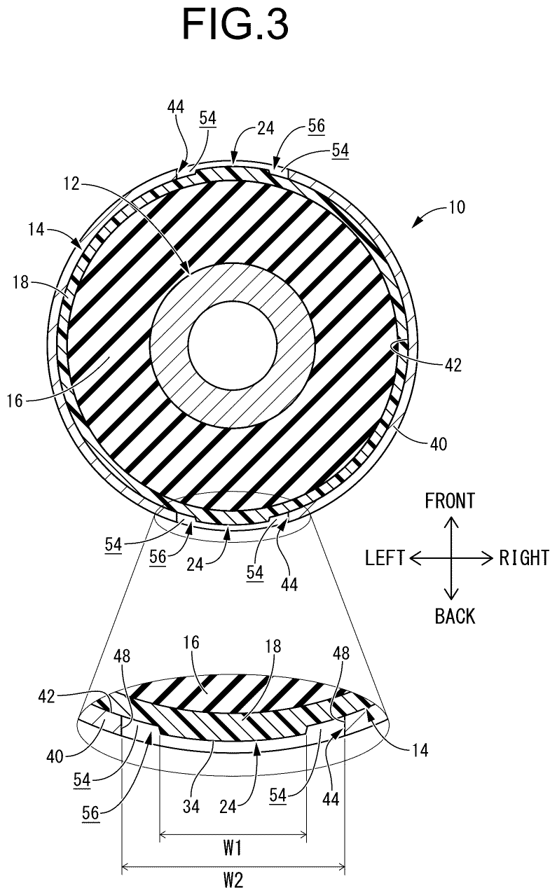

The resin outer member 14 includes a pair of detent protrusions 24, 24 that protrude from the outer circumferential surface of the tubular part 18. As shown in FIG. 1, each detent protrusion 24 has an approximately quadrangular shape when viewed in the front-back direction, and in the present practical embodiment, the detent protrusion 24 has an approximately rectangular shape. As shown in FIGS. 2 and 3, the detent protrusion 24 is provided on each side in the diametrical direction (the front-back direction). When viewed in the front-back direction, both axial ends of the detent protrusion 24 comprise a pair of first protrusion-side opposite sides 26, 26 serving as first opposite sides, which extend in the circumferential direction on a plane perpendicular to the axial direction. Meanwhile, both circumferential ends of the detent protrusion 24 comprise a pair of second protrusion-side opposite sides 28, 28 serving as second opposite sides, which extend parallel to the axial direction.

As shown in FIG. 2, the protrusion height dimension of the detent protrusion 24 from the outer circumferential surface of the tubular part 18 varies in the axial direction. Described more specifically, regarding the protruding distal end surface of the detent protrusion 24, the upper part comprises a guiding surface 30 that inclines radially inward toward the top, while the lower part comprises a locking surface 32 that inclines radially outward toward the top. Besides, a distal end surface 34 extending without inclining with respect to the axial direction is provided axially between the guiding surface 30 and the locking surface 32 on the protruding distal end surface of the detent protrusion 24. The locking surface 32 constitutes the lower first protrusion-side opposite side 26, and extends in the circumferential direction on the plane perpendicular to the axial direction.

The maximum protrusion height dimension H of the detent protrusion 24 is preferably smaller than the radial thickness dimension T of the tubular part 18 of the resin outer member 14, and more preferably within the range of ¼ to ½ of the thickness dimension T of the tubular part 18. The axial length dimension L1 of the detent protrusion 24 is preferably within the range of 1/10 to ½ of the axial length dimension L0 of the tubular part 18 of the resin outer member 14, and more preferably within the range of 1/7 to ¼. The circumferential width dimension W1 of the detent protrusion 24 is preferably within the range of 1/20 to ⅓ of the circumferential length of the tubular part 18 of the resin outer member 14, and more preferably within the range of 1/15 to ⅛.

The inclination angle α of the guiding surface 30 with respect to the axial direction is smaller than the inclination angle β of the locking surface 32 with respect to the axial direction. In the present practical embodiment, the inclination angle α of the guiding surface 30 with respect to the axial direction is constant, and the inclination angle β of the locking surface 32 with respect to the axial direction is also constant. Therefore, the axial length dimension L2 of the guiding surface 30 is larger than the axial length dimension L3 of the locking surface 32. The inclination angle α of the guiding surface 30 is preferably within the range of 2 to 10 degrees. The inclination angle β of the locking surface 32 is preferably within the range of 20 to 30 degrees. Furthermore, the inclination angle α of the guiding surface 30 may vary in size in the axial direction. Similarly, the inclination angle β of the locking surface 32 may vary in size in the axial direction. Therefore, the guiding surface 30 and the locking surface 32 are not limited to those comprising a single plane, but for example, may comprise multiple planes with mutually different inclination angles, or may comprise a curved surface with a continuously varying inclination angle.

The inner shaft member 12 is inserted through the radial inside of the resin outer member 14, and these inner shaft member 12 and resin outer member 14 are connected by the main rubber elastic body 16. The main rubber elastic body 16 has a thick-walled, approximately round tubular shape overall, with its inner circumferential surface bonded by vulcanization to the outer circumferential surface of the inner shaft member 12, while its outer circumferential surface bonded by vulcanization to the inner circumferential surface of the tubular part 18 of the resin outer member 14. The main rubber elastic body 16 takes the form of an integrally vulcanization molded component incorporating the inner shaft member 12 and the resin outer member 14.

The lower end surface of the main rubber elastic body 16 is a curved surface with a concave hollow opening downward. On the radially outer side of the said hollow, the main rubber elastic body 16 includes a first stopper part 36 protruding downward. The first stopper part 36 is fastened to the lower surface of the flanged part 20 of the resin outer member 14, and protrudes downward from the flanged part 20. A second stopper part 38 covering the upper surface of the resin outer member 14 and protruding upward from the resin outer member 14 is integrally provided with the radially outer end of the main rubber elastic body 16.

The sub-frame mount 10 of the above construction is used in a state of being fitted into a tubular collar member 40, as shown in FIGS. 1 to 3. The collar member 40, for example, constitutes a part of the sub-frame, and has an approximately round tubular shape including an attachment hole 42. The collar member 40 is a high-rigidity component formed of a metal such as iron.

The collar member 40 includes a pair of windows 44, 44 separately formed on each side in the front-back direction. Each window 44 penetrates the circumferential wall of the attachment hole 42 in the radial direction. The window 44 has an approximately quadrangular shape when viewed in the front-back direction, and in the present practical embodiment, the window 44 has an approximately rectangular shape with rounded corners. In the window 44, both axial ends of the opening peripheral rim comprise a pair of first window-side opposite sides 46, 46 serving as first opposite sides, which are located on the plane perpendicular to the axial direction, while both circumferential ends of the opening peripheral rim comprise a pair of second window-side opposite sides 48, 48 serving as second opposite sides, which extend approximately parallel to the axial direction.

The window 44 has a larger area when viewed in the front-back direction than the detent protrusion 24 of the resin outer member 14. Besides, as shown in FIG. 1, the ratio of the left-right width dimension to the vertical length dimension of the window 44 is larger than the ratio of the left-right width dimension to the vertical length dimension of the detent protrusion 24, and the window 44 has a flat shape that is longer than the detent protrusion 24 in the left-right direction.

The axial length dimension L4 of the window 44 is preferably larger than the axial length dimension L1 of the detent protrusion 24 of the resin outer member 14, and more preferably 1.05 times or more as large as the axial length dimension L1 of the detent protrusion 24. Besides, the circumferential width dimension W2 of the window 44 is larger than the circumferential width dimension W1 of the detent protrusion 24 of the resin outer member 14. The circumferential width dimension W2 of the window 44 is preferably within the range of 1.1 to 3 times the circumferential width dimension W1 of the detent protrusion 24, and more preferably within the range of 1.2 to 2 times.

The axial length dimension L4 of the window 44 is preferably within the range of ⅛ to ½ of the axial length dimension L5 of the collar member 40, and more preferably within the range of ⅕ to ⅓. Besides, the circumferential width dimension W2 of the window 44 is preferably within the range of 1/30 to ⅓ of the circumferential length of the collar member 40, and more preferably within the range of 1/20 to ⅕.

The resin outer member 14 of the sub-frame mount 10 is fitted into the attachment hole 42 of the collar member 40. The outer diameter dimension of the tubular part 18 of the resin outer member 14 is slightly larger than the inner diameter dimension of the collar member 40, and the tubular part 18 is fitted into the collar member 40 with a tightening allowance in the radial direction. In addition, the flanged part 20 provided at the lower end of the resin outer member 14 comes into contact with the lower end face of the collar member 40 in the vertical direction, thereby setting the relative position of the resin outer member 14 in the axial direction with respect to the collar member 40.

Since the outer circumferential surface of the upper end of the resin outer member 14 comprises the tapered surface 22 that tapers upward, the resin outer member 14 can be easily inserted into the collar member 40 from below. In the present practical embodiment, the minimum outer diameter dimension of the tapered surface 22 is smaller than the inner diameter dimension of the collar member 40. By inserting the upper end of the resin outer member 14 into the collar member 40, the resin outer member 14 and the collar member 40 can be positioned relative to each other in the radial direction before being fitted.

The detent protrusion 24 that protrudes from the outer circumferential surface of the resin outer member 14 is inserted into the window 44 of the collar member 40. The protruding distal end surface of the detent protrusion 24 comprises the guiding surface 30 having an inclined shape whose distal end side to be fitted into the collar member 40 tapers in the direction of fit. This makes it easy for the collar member 40 to climb over the detent protrusion 24, thereby making it easy to insert the detent protrusion 24 into the window 44.

The lower opening peripheral rim of the window 44 (the first window-side opposite side 46) is located on the locking surface 32 of the detent protrusion 24, and is locked with respect to the detent protrusion 24 in the axial direction. With this configuration, the resin outer member 14 is less likely to become dislodged from the collar member 40 by downward displacement. In particular, in the resin outer member 14 made of synthetic resin, since the tubular part 18 is fitted into the collar member 40, radially inward force is continuously exerted on the tubular part 18 from the collar member 40, and the tubular part 18 may experience plastic deformation (permanent deformation), posing a risk of deteriorating the resistance to dislodgement of the tubular part 18 by means of its fit into the collar member 40. To address this issue specific to the resin outer member 14, the present disclosure is provided with a locking structure in the axial direction between the detent protrusion 24 and the opening peripheral rim of the window 44 of the collar member 40. With this structure, even if the detent resistance to dislodgement by means of the fit is deteriorated due to permanent deformation of the tubular part 18 of the resin outer member 14, the locking structure by means of the detent protrusion 24 can stably ensure the required resistance to dislodgement. The resin outer member 14 is made of synthetic resin, which allows a high degree of freedom in shape. This makes it possible to set the shape, the size, and the like of the detent protrusion 24 that protrudes from the outer circumferential surface with a large degree of freedom.

The locking surface 32, which is the locking portion of the detent protrusion 24 with respect to the lower first window-side opposite side 46 of the window 44, has an inclined shape that inclines radially outward toward the distal end side in the direction of fit. With this configuration, even if relative positional misalignment in the axial direction occurs between the detent protrusion 24 and the window 44, the first window-side opposite side 46 will be stably located on the locking surface 32 of the detent protrusion 24, so that the resin outer member 14 will be stably prevented from becoming dislodged from the collar member 40. In the present practical embodiment, an edge 50 of the first window-side opposite side 46 of the collar member 40 is wedged into the locking surface 32 of the detent protrusion 24. Thus, a stronger detent action is exhibited, and even if the relative positions of the detent protrusion 24 and the window 44 are misaligned in the axial direction, the first window-side opposite side 46 of the window 44 is readily locked in a state of contact with the locking surface 32 of the detent protrusion 24. The first window-side opposite side 46 that includes the edge 50 extends in the circumferential direction on the plane perpendicular to the axial direction.

Besides, in the detent protrusion 24, the inclination angle of the locking surface 32 is larger than the inclination angle of the guiding surface 30. With this configuration, the collar member 40 is guided by the guiding surface 30 having a small inclination angle, so that the collar member 40 readily climbs over the detent protrusion 24. Additionally, the locking surface 32 having a large inclination angle is effectively caught and locked by the first window-side opposite side 46 of the window 44, thereby obtaining large resistance force of the resin outer member 14 to dislodgment from the collar member 40.

The detent protrusion 24 and the windows 44 are respectively provided on each side of the resin outer member 14 and the collar member 40 in the diametrical direction. Therefore, on each side in the diametrical direction where the detent protrusion 24 and the window 44 are formed, the resistance force of the resin outer member 14 to dislodgement from the collar member 40 is exerted, and the resin outer member 14 is more resistant to dislodgement from the collar member 40. Besides, since the resistance to dislodgement of the resin outer member 14 from the collar member 40 acts on each side in the diametrical direction, the moment caused by the said resistance to dislodgement is offset, thereby preventing tilting motion (prizing displacement) or the like of the resin outer member 14 and the collar member 40 caused by the resistance to dislodgement.

The first protrusion-side opposite side 26 of the detent protrusion 24 that is constituted by the locking surface 32 and the first window-side opposite side 46 of the window 44 that is locked to the locking surface 32 both extend in a direction perpendicular to the axial direction. With this configuration, the locking portion between the locking surface 32 of the detent protrusion 24 and the first window-side opposite side 46 of the window 44 extends in the direction perpendicular to the axial direction. Therefore, the resistance force of the resin outer member 14 to dislodgment in the axial direction from the collar member 40 is more efficiently exerted by the lock between the locking surface 32 of the detent protrusion 24 and the first window-side opposite side 46 of the window 44.

The axial width dimension of the detent protrusion 24 is smaller than that of the window 44, as shown in FIGS. 1 and 2. Thus, the upper first protrusion-side opposite side 26 of the detent protrusion 24 and the upper first window-side opposite side 46 of the window 44 are remote from each other in the axial direction. With this configuration, an axial gap 52 is formed axially between the upper first protrusion-side opposite side 26 of the detent protrusion 24 and the upper first window-side opposite side 46 of the window 44. The axial gap 52 is provided continuously across the entire circumferential length of the detent protrusion 24.

The circumferential width dimension of the detent protrusion 24 is smaller than that of the window 44. Thus, as shown in FIGS. 1 and 3, the second protrusion-side opposite sides 28, 28 of the detent protrusion 24 and the second window-side opposite sides 48, 48 of the window 44 are remote from each other in the circumferential direction. Accordingly, respective circumferential gaps 54 are formed circumferentially between the second protrusion-side opposite sides 28, 28 and the second window-side opposite sides 48, 48. The circumferential gaps 54, 54 are provided continuously across the entire axial length of the detent protrusion 24. The circumferential gaps 54, 54 formed on both sides of the detent protrusion 24 in the circumferential direction may have mutually different circumferential width dimensions.

The circumferential gaps 54, 54 are continuous with the axial gap 52 at the upper end, and the circumferential gaps 54, 54 and the axial gap 52 form a gap 56 that extends continuously in an approximate form of a vertically inverted U letter around the detent protrusion 24. Regarding the gap 56 of the present practical embodiment, a circumferential width dimension D2 of the circumferential gap 54 is larger than an axial width dimension D1 of the axial gap 52, as shown in FIG. 1.

With such a gap 56 formed, relative positional misalignment and dimensional errors between the detent protrusion 24 of the resin outer member 14 and the window 44 of the collar member 40 will be allowed by the gap 56. Therefore, for example, the detent protrusion 24 is prevented from overlapping the radial inside of the collar member 40 at a position away from the window 44, and the locking surface 32 of the detent protrusion 24 and the lower first window-side opposite side 46 of the window 44 are stably locked, thereby effectively obtaining the desired detent action.

In the present practical embodiment, the width dimension D2 of the circumferential gap 54 is larger than the width dimension D1 of the axial gap 52. With this configuration, relative positional misalignment in the circumferential direction between the detent protrusion 24 of the resin outer member 14 and the window 44 of the collar member 40 is allowed to be larger than relative positional misalignment in the axial direction. Both the detent protrusion 24 and the window 44 are provided at a position that is radially remote from the center axis O of the sub-frame mount 10 and the collar member 40. As a result, even if the resin outer member 14 and the collar member 40 are misaligned in the circumferential direction by a small rotation angle, the relative misalignment between the detent protrusion 24 and the window 44 is likely to become comparatively large. Therefore, in the circumferential direction where a large positional misalignment is likely to occur, the large circumferential gaps 54, 54 that have a large width dimension are aimed at allowing positional misalignment in the circumferential direction, thereby making it difficult for the detent protrusion 24 to be detached from the window 44 when the sub-frame mount 10 is mounted to the collar member 40.

In the present practical embodiment, the detent protrusion 24 and the window 44 are each approximately rectangular, and the first protrusion-side opposite side 26 of the detent protrusion 24 and the first window-side opposite side 46 of the window 44, which are spaced apart by the axial gap 52, are mutually opposed at a certain distance in the circumferential direction. Therefore, without the need for excessively increasing the width dimension D1 of the axial gap 52, it is possible to allow the relative positional misalignment in the axial direction between the detent protrusion 24 and the window 44 with good space efficiency. Besides, the second protrusion-side opposite sides 28, 28 of the detent protrusions 24 and the second window-side opposite sides 48, 48 of the window 44, which are spaced apart by the respective circumferential gaps 54, 54, are mutually opposed at a certain distance in the axial direction. Therefore, without the need for excessively increasing the width dimension D2 of the circumferential gap 54, it is possible to allow the relative positional misalignment in the circumferential direction between the detent protrusion 24 and the window 44 with good space efficiency.

A practical embodiment of the present disclosure has been described in detail above, but the present disclosure is not limited to those specific descriptions. For example, in the preceding first practical embodiment, the detent protrusion 24 and the window 44 are formed on each side in the diametrical direction. However, the number of the detent protrusion 24 and the window 44 is not particularly limited, but one each of them may be formed, or two or more each of them may be formed. When the detent protrusion 24 and the window 44 are provided in plurality, it is desirable that the detent protrusions 24 and the windows 44 be dispersedly arranged at regular intervals in the circumferential direction. However, their circumferential arrangement is not limited as long as the detent protrusions 24 and the windows 44 are provided in positions corresponding to each other.

Additionally, there may be multiple pairs of the detent protrusions 24 and the windows 44 located at mutually different positions in the axial direction. Furthermore, when there are multiple pairs of the detent protrusions 24 and the windows 44 arranged in the circumferential direction, the axial positions of the multiple pairs of the detent protrusions 24 and the windows 44, which are located at different positions in the circumferential direction, may be different from each other.

The shape of the detent protrusion when viewed in the direction of protrusion is not necessarily limited to a square or a rectangle, but may be, for example, a quadrilateral such as a trapezoid and a parallelogram, a triangle or a polygon with five or more sides, a circle including an ellipse, or the like. Besides, the shape of the opening of the window is not necessarily limited to a square or a rectangle, and various shapes can be adopted, similarly to the detent protrusion. It is desirable that the detent protrusion and the window locked to the detent protrusion have shapes that correspond to each other when viewed in the direction of protrusion of the detent protrusion 24, but they may have different shapes from each other.

The guiding surface 30 of the detent protrusion 24 is not essential. For example, the collar member 40 may be provided with a tapered surface having an expanded shape on the inner circumferential surface of the opening portion on the side into which the resin outer member 14 is fitted. With this configuration, even the detent protrusion 24 without the guiding surface 30 readily climbs over the collar member 40 when the resin outer member 14 is fitted into the collar member 40. Besides, the distal end surface 34 of the detent protrusion 24 may be omitted, and for example, the guiding surface 30 and the locking surface 32 may be directly continuous with each other without interposing the distal end surface 34.

The axial length dimension L1 of the detent protrusion 24 may be larger than the axial length dimension L4 of the window 44. In this case, a part of the locking surface 32 of the detent protrusion 24 is positioned away from the window 44 in the axial direction, thereby forming the axial gap 52.

In the preceding first practical embodiment, the sub-frame mount 10 is shown as an example of a tubular vibration-damping device. However, the tubular vibration-damping device according to the present disclosure is not limited to application in sub-frame mounts, but is also suitable for application in engine mounts, motor mounts, torque rods, suspension bushings, and the like.

What is claimed is:

1. A tubular vibration-damping device comprising:
a resin outer member having a tubular shape and including a detent protrusion that protrudes from an outer circumferential surface of the resin outer member;
an inner shaft member inserted through the resin outer member; and
a main rubber elastic body connecting the inner shaft member and the resin outer member to each other, wherein
a collar member having a tubular shape into which the resin outer member is fitted includes a window into which the detent protrusion is inserted,
around the detent protrusion, a gap is provided between the window and the detent protrusion on a distal end side in a direction of fit of the resin outer member into the collar member and between the window and the detent protrusion on both sides in a circumferential direction, and
an end surface of the detent protrusion on a proximal end side in the direction of fit of the resin outer member into the collar member comprises a locking surface that inclines radially outward toward the distal end side in the direction of fit, and the collar member is locked to the locking surface in an axial direction.

2. The tubular vibration-damping device according to claim 1, wherein
an end surface of the detent protrusion on the distal end side in the direction of fit of the resin outer member into the collar member comprises a guiding surface that inclines radially outward toward the proximal end side in the direction of fit, and
an inclination angle of the guiding surface with respect to the direction of fit is smaller than that of the locking surface.

3. The tubular vibration-damping device according to claim 1, wherein the detent protrusion is provided on each side in a diametrical direction.

4. The tubular vibration-damping device according to claim 1, wherein the gap between the window and the detent protrusion is made larger in the circumferential direction than in the axial direction.

5. The tubular vibration-damping device according to claim 1, wherein the locking surface of the detent protrusion and an opening peripheral rim of the window of the collar member locked to the locking surface both extend in a direction perpendicular to the axial direction.

6. The tubular vibration-damping device according to claim 5, wherein when viewed in a direction of protrusion of the detent protrusion, the detent protrusion and the window include respective pairs of first opposite sides extending in the direction perpendicular to the axial direction and respective pairs of second opposite sides extending in the axial direction.
